(19) United States
(12) Patent Application Publication
(10) Pub. No.: US 2014/0242356 A1
(43) Pub. Date: Aug. 28, 2014

(54) MULTILAYER CARD COMPRISING A FIBROUS OUTER LAYER

(71) Applicant: Thibaut Le Loarer, Pommier De Beaurepaire (FR)

(72) Inventor: Thibaut Le Loarer, Pommier De Beaurepaire (FR)

(73) Assignee: ARJOWIGGINS SECURITY, Boulogne Billancourt (FR)

(21) Appl. No.: 13/813,402

(22) PCT Filed: Jul. 13, 2011
(86) PCT No.: PCT/IB01/53137

§ 371 Date: May 8, 2014

(30) Foreign Application Priority Data
Jul. 30, 2010 (FR) 1056348

(51) Int. Cl. B32B 5/02; B32B 38/00; B32B 3/10

(52) U.S. Cl. CPC B32B 5/02; B32B 3/10; B32B 38/145
USPC 428/196; 156/60; 427/256; 428/221

(57) ABSTRACT

The present application relates to a multilayer card comprising a fibrous outer layer. The fibrous outer layer comprises between about 55 wt % and about 80 wt % of natural fibers, and between about 3 wt % and about 10 wt % of synthetic fibers, and between about 9 wt % and about 20 wt % of inorganic fillers. The fibrous outer layer further comprises a binder and a softener. The binder may be a mixture of PVA and starch or a latex. The softener may be glycerin, urea, sodium nitrate, or mixtures thereof. The fibrous outer layer is printed upon and/or comprises a security element.

The present invention relates to the field of multilayer cards and, more particularly, to the multilayer cards of bank card, social security card or identity card type, comprising one or more security elements.

### BACKGROUND

It is known practice to manufacture multilayer cards by laminating a plurality of layers of plastic material (PVC, PC, PET, etc.). However, the use of an outer layer made of plastic material can yield a card that has poor printability, in particular by inkjet printing.

Printing/writing-type papers are known that comprise inorganic fillers in their mass or on the surface which make them printable by offset and inkjet printing. Such papers can, however, exhibit mechanical characteristics that are not entirely satisfactory for a card-type application.

Moreover, multilayer structures comprising a layer of paper are known from the following documents.

WO 2009/007659 describes an insert comprising a chip module and a wired antenna. The module opens onto the outer surface of the insert. Since said insert is intended to be incorporated in a passport or an identity card, it constitutes an internal layer which is consequently not intended to be printed upon.

WO 2006/101493 describes a multilayer structure comprising a printable layer that is notably formed from synthetic paper of Teslin® type. The multilayer structure further comprises an intermediate layer comprising a thermosetting polymer as well as a base layer on the surface of which electronic components are mounted. Teslin® is a plastic material which is neither fibrous nor cellulosic. This multilayer structure may be printable by inkjet printing but its successive folding endurance may not be entirely satisfactory.

WO 2006/077339 describes layers of paper charged with synthetic fibers in order to reinforce their internal cohesion.

There is a need to have a multilayer card that can be printed upon, in particular by inkjet and offset printing.

There is a need to secure, without excessively affecting their mechanical properties, multilayer cards by means of securing mechanisms known in the field of security papers.

There is a need to have a multilayer card that substantially retains the mechanical properties of a plastic material, while being able to be customized by printing, in particular by inkjet and offset printing.

There is also a need to reduce the proportion of plastic materials in the multilayer cards, in particular in order to replace them with biodegradable and renewable materials.

The present invention aims to address all or some of the abovementioned needs.

### SUMMARY

According to a first of its aspects, the invention relates to a multilayer card comprising a fibrous outer layer, the fibrous outer layer comprising at least:

relative to the total weight of the fibrous outer layer, between 55 wt % and 80 wt % of natural fibers, preferably between 60 wt % and 65 wt %,

relative to the total weight of the fibrous outer layer, between 3 wt % and 10 wt % of synthetic fibers, preferably between 4 wt % and 8 wt %,

relative to the total weight of the fibrous outer layer, between 9 wt % and 20 wt % of inorganic fillers, preferably between 12 wt % and 16 wt %,

a binder, in particular a mixture of PVA and starch or a latex, preferably chosen from among the acrylic, styrene-butadiene or butadiene latexes, and

a softener, in particular glycerin, urea, sodium nitrate or one of the mixtures thereof,

the fibrous outer layer being printed upon and/or comprising a security element, which is in particular luminescent.

In the presence of an RFID chip, the chip advantageously does not open onto the outer surface of the fibrous outer layer.

The three-fold association of synthetic fibers, a binder and a softener advantageously makes it possible to confer upon the fibrous outer layer enhanced properties of elasticity, flexibility and dual-fold endurance.

The presence of inorganic fillers advantageously makes it possible to confer upon the fibrous outer layer properties of printability, in particular the ability to be printed by offset and inkjet printing.

The printing of the fibrous outer layer may consist of a variable text such as, for example, the name or the photograph of the holder of the multilayer card according to the invention.

All or part of the printing and/or of the security element of the fibrous outer layer may be visible. In other words, at least a part of the printing and/or of the security element of the fibrous outer layer of a multilayer card according to the invention may be visible to a user of said multilayer card.

The resolution of the printing of the fibrous outer layer may be greater than 600 dpi.

Unless otherwise stipulated, all the percentage weights of the compounds contained in the fibrous outer layer are given as dry weight.

Natural Fibers

The natural fibers may be present in the fibrous outer layer in the form of a mixture of long natural fibers (resinous-derived) and of short natural fibers (foliaceous-derived).

The long natural fibers may, for example, be used to enhance the mechanical resistance and the short natural fibers may, for example, be used to confer opacity.

In an exemplary embodiment, the percentage weight of short natural fibers, within the fibrous outer layer, may be less than or equal to the percentage weight of long natural fibers. Thus, at least 50% by weight of the natural fibers may be long natural fibers. Preferably, at least 80% by weight of the natural fibers are long natural fibers.

The natural fibers may be formed wholly or partly from cellulosic fibers, and may in particular be all cellulosic fibers.

Synthetic fibers

The synthetic fibers can, for example, be chosen from among rayon fibers, in particular rayon staple fiber or viscose, or of a thermoplastic material, in particular a polyamide, a polyester, a polyolefin and/or a mixture of such fibers.

The percentage weight of synthetic fibers in the fibrous outer layer can be evaluated, for example, by a three-dimensional measurement by stereology on two-dimensional cuts using a scanning electron microscope.

A plurality of images in cross section can be acquired, in the direction of operation of the paper machine (SM) and in the cross-wise direction (ST).

The number of synthetic fibers intercepted by the cut for each image is counted for each paper direction, namely Nₛₜ and Nₛₘ. The average number of synthetic fibers in the paper is calculated by N=\sqrt{Nₛₜ×Nₛₘ}.

The total length L of paper counted is given by the sum of the lengths of the images counted.

The number of fibers per linear meter of paper is given by

$${N}_{m l} = \frac{N}{L} .$$

The weight of synthetic fibers per square meter, w, is calculated by using the titer count (or weight per unit length) T of the synthetic fibers expressed in decitex (weight in grams of 10 000 m of fibers) and Nₘₗ using the following formula:

$$w = ( \frac{π}{2} ) \times {N}_{m l} \times T .$$

The rate of synthetic fibers is obtained by dividing this weight by the basis weight of the fibrous outer layer. Preferably, the number of images is sufficient to count at least 400 synthetic fibers, in order to reduce the inaccuracy of the method.

In an exemplary embodiment, at least 50% by weight of the synthetic fibers can be polyamide fibers.

The synthetic fibers can, for example, have an average length greater than 4 mm, for example 6 mm.

The synthetic fibers can, for example, have an average length of 6 mm.

The average diameter of the synthetic fibers can be between 0.9 and 4.2 dtex, for example between 0.9 and 3.3 dtex, even better between 1.2 and 1.7 dtex.

Inorganic Fillers

The inorganic fillers can be chosen from among silica, sodium silicates and aluminosilicates, carbonates, in particular of calcium, talc, kaolin, aluminohydrate, titanium dioxide and the mixtures thereof.

The fibrous outer layer can, for example, comprise silica, sodium aluminosilicate and titanium dioxide as inorganic fillers.

Silica and sodium aluminosilicate can, for example, be used for the printability, and titanium dioxide for the opacity and whiteness.

The fibrous outer layer can comprise silica in a percentage weight between 1 wt % and 10 wt %, preferably between 6 wt % and 8 wt %, relative to the total weight of the fibrous outer layer.

The fibrous outer layer may comprise sodium aluminosilicate in a percentage weight between 1 wt % and 9 wt %, preferably between 5 wt % and 7 wt %, relative to the total weight of the fibrous outer layer.

The fibrous outer layer may comprise titanium dioxide in a percentage weight between 2 wt % and 9 wt %, preferably between 4 wt % and 7 wt %, relative to the total weight of the fibrous outer layer.

Binder and Softener

The binder can advantageously be chosen from among the thermoplastic polymers with a glass transition temperature Tg less than or equal to +20° C., better 10° C., to provide flexibility.

In an exemplary implementation, the fibers of the fibrous base are bound with a mass-precipitated binder, the binder of the fibrous base being, for example, chosen from among the polymers of Tg less than or equal to −10° C., being for example chosen from among the styrene-butadiene copolymers, the acrylic polymers and the vinyl acetates and their copolymers.

In an exemplary implementation of the invention, the binder is, for example, introduced into the fibrous base by surfacing, the binder of the fibrous base being chosen, for example, from among the polymers of Tg less than or equal to +10° C., the binder of the fibrous base comprising, for example, a natural binder, in particular starch, or a synthetic binder, in particular polyvinyl alcohol or an acrylic styrene polymer, for example of Tg around 7° C.

The coating binder advantageously comprises a thermoplastic material, the quantity of thermoplastic material being, for example, adjusted to obtain in the coating a concentration of between 10 and 20 g/m² dry in order to obtain a good printability (too great a concentration of binder potentially degrading the printability) while retaining the “non-marking bending” of the fibrous layer, the coating binder of the surface layer being able, for example, to comprise a polymer or a copolymer of styrene-butadiene, acrylic, acrylic styrene or vinylic nature.

The binder can, for example, be chosen from among the latexes. Preferably, the binder is chosen from among the acrylic, styrene-butadiene or butadiene latexes and also preferably for reasons of durability, in particular resistance to UV and resistance to aging, from among the acrylic latexes.

The binder can be chosen from among PVA, starch and the mixtures thereof, preferably a mixture of PVA and starch.

The binder may be present within the fibrous outer layer in a percentage weight of between 3 wt % and 15 wt %, preferably between 7 wt % and 12 wt %.

The binder of the fibrous layer can, for example, be associated with a softener. The latter can be chosen from among glycerin, the urea/sodium nitrate mixture, or the mixtures thereof.

The softener is a compound that makes it possible to lubricate the individual fibers in the fibrous network that the paper is made up of, and it can be a tension-active product. Such a softener used in the manufacture of the paper can have the effect of giving the paper a soft touch and a high elasticity.

The softener may be present within the fibrous outer layer in a percentage weight of between 2 wt % and 12 wt %, preferably between 3 wt % and 7 wt %.

It is possible, for example, to use the urea/sodium nitrate mixture as softener, preferably with a weight ratio

$$\frac{urea}{sodium nitrate}$$

of between 1 and 5, for example between 1.5 and 3.

It is also possible to use glycerin.

It may be advantageous for the ratio between the percentage weight of binder and the percentage weight of inorganic fillers, in the fibrous outer layer, to be between 0.25 and 1.5, preferably between 0.5 and 1.

The fibrous outer layer can have a basis weight of between 90 and 175 g/m², for example between 100 and 150 g/m².

The fibrous outer layer according to the invention can comprise any type of security elements known to the person skilled in the art, notably chosen from among the security elements described later.

Independently or in combination with the above, the present invention relates, according to another of its aspects, to a multilayer card comprising a fibrous outer layer, the fibrous outer layer comprising:

relative to the total weight of the fibrous outer layer, between 55 wt % and 80 wt % of natural fibers, preferably between 60 wt % and 65 wt %,

relative to the total weight of the fibrous outer layer, between 3 wt % and 10 wt % of synthetic fibers, preferably between 4 wt % and 8 wt %,

relative to the total weight of the fibrous outer layer (2; 2A; 2B), between 9 wt % and 20 wt % of inorganic fillers, preferably between 12 wt % and 16 wt %,

a binder, in particular a mixture of PVA and starch or a latex, preferably chosen from among the acrylic, styrene-butadiene or butadiene latexes, and

a softener, in particular glycerin, urea, sodium nitrate or one of the mixtures thereof,

the fibrous outer layer being intended to be printed upon in particular by offset and/or inkjet printing on its outer surface.

Independently or in combination with the above, the present invention relates, according to another of its aspects, to a multilayer card comprising a fibrous outer layer, the fibrous outer layer comprising:

relative to the total weight of the fibrous outer layer, between 55 wt % and 80 wt % of natural fibers, preferably between 60 wt % and 65 wt %,

relative to the total weight of the fibrous outer layer, between 3 wt % and 10 wt % of synthetic fibers, preferably between 4 wt % and 8 wt %,

relative to the total weight of the fibrous outer layer, between 9 wt % and 20 wt % of inorganic fillers, preferably between 12 wt % and 16 wt %,

a binder, in particular a mixture of PVA and starch or a latex, preferably chosen from among the acrylic, styrene-butadiene or butadiene latexes, and

a softener, in particular glycerin, urea, sodium nitrate or one of the mixtures thereof,

the fibrous outer layer being printed upon, in particular by offset or inkjet printing, on its outer surface.

The printing may be a pre-printing and the card may be supplied to the user already printed, for example by offset printing. The user can then, if he wishes, personalize the card, for example by inkjet printing, in order to inscribe thereon his or her name, address, photograph or any other personal information.

Independently or in combination with the above, the present invention relates, according to another of its aspects, to a multilayer card comprising a fibrous outer layer, the fibrous outer layer comprising:

relative to the total weight of the fibrous outer layer, between 55 wt % and 80 wt % of natural fibers, preferably between 60 wt % and 65 wt %,

relative to the total weight of the fibrous outer layer, between 3 wt % and 10 wt % of synthetic fibers, preferably between 4 wt % and 8 wt %,

relative to the total weight of the fibrous outer layer, between 9 wt % and 20 wt % of inorganic fillers, preferably between 12 wt % and 16 wt %,

a binder, in particular a mixture of PVA and starch or a latex, preferably chosen from among the acrylic, styrene-butadiene or butadiene latexes, and

a softener, in particular glycerin, urea, sodium nitrate or one of the mixtures thereof,

at least one dimension of the card conforming to the ISO 7810 and/or 7813 standard.

In an exemplary embodiment, the thickness of the card at least conforms to the ISO 7813 standard. In other words, the card has a thickness of 760 μm+/−80 μm.

According to another of its aspects, the present invention relates to a method for manufacturing a multilayer card as described above comprising at least the steps consisting in:

positioning at least one fibrous outer layer as described above facing one face of the card body,

assembling, in particular by hot lamination, the fibrous outer layer and said card body.

The card body and/or the fibrous outer layer may comprise an adhesive coating on at least one face. It is possible, for example, to use a heat-activated adhesive or a pressure-sensitive adhesive. Preferentially, the adhesive will be chosen from among the heat-activated adhesives comprising, for example, a polymer chosen from among polyurethane, polyethylene, the acrylic or vinylic polymers, for example polyvinylacetate and the mixtures thereof.

The assembly of the card body and said at least one fibrous outer layer can, for example, be done by hot lamination techniques known to the person skilled in the art. The card body may itself comprise one or more layers made of paper and/or plastic material.

According to another of its aspects, the present invention relates to a method for manufacturing a fibrous outer layer, for example as described above, comprising at least the steps consisting in:

a) having a fibrous suspension comprising natural fibers, then

b) adding the synthetic fibers to said fibrous suspension so as to obtain a fibrous composition, and

c) adding the inorganic fillers to said fibrous composition or to said fibrous suspension.

It is, for example, possible for the fibrous suspension to be refined before the step b).

The method described above may also comprise the addition of a composition comprising at least one binder, for example by mass precipitation.

The method described above may also comprise, after the addition of the synthetic fibers, the addition of a composition comprising at least one binder, for example by impregnation, surfacing, coating and/or spreadcoating. In this case, the inorganic fillers may be contained in said composition and thus be added during the impregnation, the surfacing, the coating and/or the spreadcoating. Any known method or device can be used for this, notably an impregnator, a size press, a film press, an air knife or knife coating machine, a curtain coating machine, a Champion coating machine, a helio coating machine or a film transfer coating machine, for example such as a “Twin-HSM” coating machine from the company BTG.

Said composition comprising at least one binder is preferably added by means of an impregnator or a size press.

The fibrous composition obtained after one of the steps b) or c) may be dripped, pressed and dried according to the current paper-making method, for example before the addition of the binder.

According to another of its aspects, the present invention relates to an article comprising, notably consisting of, a multilayer card as described above in which at least a part of the printing and/or of the security element of the fibrous outer layer is visible.

The multilayer card may be clad within said article by one or more transparent layers, for example made of thermoplastic material.

According to another of its aspects, the present invention relates to a method for manufacturing a printed document in which a multilayer card is printed comprising a fibrous outer layer, the fibrous outer layer comprising:

relative to the total weight of the fibrous outer layer, between 55 wt % and 80 wt % of natural fibers, preferably between 60 wt % and 65 wt %,

relative to the total weight of the fibrous outer layer, between 3 wt % and 10 wt % of synthetic fibers, preferably between 4 wt % and 8 wt %,

relative to the total weight of the fibrous outer layer, between 9 wt % and 20 wt % of inorganic fillers, preferably between 12 wt % and 16 wt %,

a binder, in particular a mixture of PVA and starch or a latex, preferably chosen from among the acrylic, styrene-butadiene or butadiene latexes, and

a softener, in particular glycerin, urea, sodium nitrate or one of the mixtures thereof.

The printing may, for example, be offset, inkjet or photogravure printing.

The ink used for the printing may, for example, comprise a coloring agent such as a colorant and/or pigments, notably luminescent pigments.

Mechanical Characteristics of the Fibrous Outer Layer

The fibrous outer layer according to the invention may not exhibit marking on bending. In practice, when the two lengthwise edges of a card ID-1 comprising at least one fibrous outer layer according to the invention, conforming to the ISO 7810 and 7813 standards (for example described in the examples below), are brought into contact by folding, the fibrous outer layer exhibits no mark, no fold, no deformation that is irreversible. Such a property is not exhibited by a card ID-1 that is entirely plastic which will break or will be marked irreversibly even before its two edges are in contact.

Since this property is exceptional for a multilayer card, it is not described by any norm or standard. The applicant has therefore sought to define the mechanical characteristics of the fibrous outer layer which make it possible to obtain a product that exhibits no mark, no fold, no deformation that is irreversible in the conditions described above. After a number of tests, the applicant has demonstrated that the composition according to the invention makes it possible to obtain a fibrous outer layer that exhibits the following characteristics and that exhibits no mark, no fold, no deformation that is irreversible on folding, notably as described above. In particular, at least two of the mechanical characteristics presented below, preferably all three, are borne out by the fibrous outer layer according to the invention.

Young's Modulus

The Young's modulus is determined according to the standard ISO 1924 “paper and board—determination of tensile properties” (“part 2: constant rate of elongation method”).

The fibrous outer layer can, for example, exhibit a Young's modulus of less than 2000 MPa, preferably less than 900 MPa.

Dual-Fold Endurance

The dual-fold endurance is determined according to the standard ISO 5626 “paper—determination of folding endurance”.

The fibrous outer layer according to the invention can, for example, exhibit a dual-fold endurance (Lhommargy measurement) greater than 5000, preferably greater than 7000 and more preferentially greater than 10 000.

Elongation

The elongation is determined according to the standard ISO 1924 “paper and board-determination of tensile properties” (“part 2: constant rate of elongation method”).

The fibrous outer layer according to the invention can, for example, exhibit an elongation in the direction of operation (in the direction of production on the paper machine) greater than 5%, preferably greater than 6%.

Security Elements that Can be Integrated in the Fibrous Outer Layer

Among the security elements that can be incorporated in the fibrous outer layer, some can be detected by the eye, in daylight or in artificial light, without the use of a particular apparatus. These security elements comprise, for example, colored fibers or boards, totally or partially printed or metalized wires. The security elements are qualified as “first level”.

Other additional types of security elements can be detected only using a relatively simple apparatus, such as a lamp emitting in the ultraviolet (UV) or the infrared (IR). These security elements comprise, for example, fibers, boards, strips, wires or particles. These security elements may or may not be visible to the eye, being, for example, luminescent under the illumination of a Wood lamp emitting in a wavelength of 365 nm. These security elements are qualified as “second level”.

Other types of security elements require, for their detection, a more sophisticated detection apparatus. These security elements are, for example, capable of generating a specific signal when they are subjected, simultaneously or not, to one or more sources of external excitation. The automatic detection of the signal makes it possible to authenticate the document where appropriate. These security elements comprise, for example, tracers which take the form of active substances, particles or fibers, capable of generating a specific signal when these tracers are subjected to an optronic, electrical, magnetic or electromagnetic excitation. These security elements are qualified as “third level”.

Reagents may also be incorporated in the fibrous outer layer; these are, for example, counterfeit-prevention and/or authentication and/or identification chemical or biochemical reagents that can notably react respectively with at least one counterfeiting and/or authentication and/or identification agent.

The additional security element or elements present within the fibrous outer layer may have first, second or third level security characteristics.

### DESCRIPTION OF THE FIGURES

The invention will be able to be better understood on reading the following detailed description of nonlimiting exemplary implementations thereof, and on studying the appended drawing, in which:

FIG. 1 represents an exemplary embodiment of a multilayer card according to the invention,

FIG. 2 represents a transversal section along II-II of the card of FIG. 1,

FIG. 3 represents a variant embodiment of a card body used within a multilayer card according to the invention, and

FIG. 4 represents a variant embodiment of a multilayer card according to the invention.

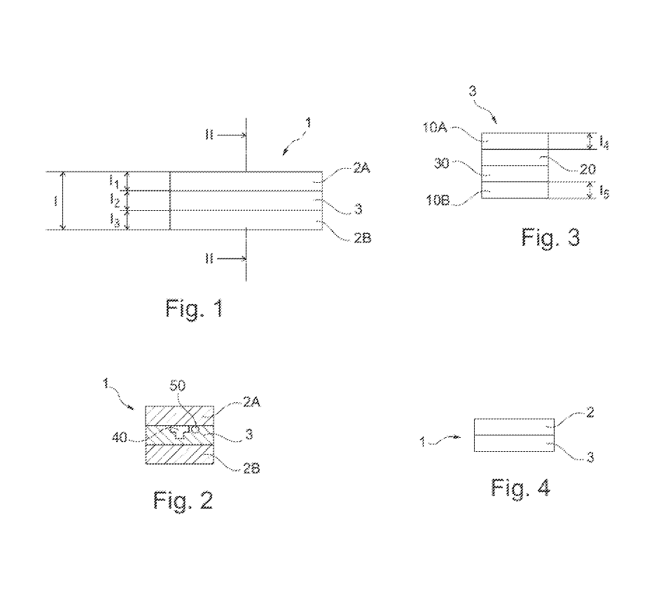

FIG. 1 shows a multilayer card 1 comprising two fibrous outer layers 2A and 2B arranged on either side of a card body 3.

Adhesive layers, which are not represented, may extend between the card body 3 and the fibrous outer layers 2A and 2B so as to ensure the cohesion of the multilayer card 1.

The fibrous outer layers 2A and 2B may, for example, have respective thicknesses l₁ and l₃ each of between 50 and 500 μm, for example between 50 and 200 μm.

In the exemplary embodiment illustrated in FIG. 1, the values of l₁ and l₃ are substantially identical.

The card body 3 may, for example, have a single-layer structure as represented in FIG. 1.

FIG. 3 shows a variant embodiment in which the card body 3 has a multilayer structure, which comprises two layers of plastic material 10A and 10B arranged on either side of two paper layers 20 and 30.

Adhesive layers may extend between the different layers so as to ensure the cohesion of the card body 3.

In the exemplary embodiment of FIG. 3, the two layers of plastic material 10A and 10B comprise, for example, PVC or PET, and have, for example, respective thicknesses l₄ and l₅ of between 50 and 200 μm. The thicknesses l₄ and l₅ may, as represented, be substantially equal or, as a variant, be of different values.

Obviously, in variants that are not illustrated, the card body 3 may have a multilayer structure consisting only of paper layers or only of layers made of plastic material.

FIG. 2 shows a transversal section of the multilayer card 1 of FIG. 1. An RFID chip 40 and an antenna 50 can, for example, be included in the card body 3 and not open onto the outer surface of the fibrous layers 2A and 2B.

FIG. 4 shows a variant embodiment in which the multilayer card 1 according to the invention comprises only a single fibrous outer layer 2. Such a card is, for example, intended to receive printing, preferably inkjet, on said single fibrous outer layer.

### EXAMPLES

### Example 1

### Method for Preparing a Fibrous Outer Layer According to the Invention

There is a fibrous suspension having the composition A below.

Composition A

| | | Dry weight in kg |
|---|---|---|
| Natural fibers | | |
| Long fibers (FL) | | 1000 kg |
| Short fibers (FC) | | 250 kg |
| Fillers | | |
| Titanium dioxide | | 50 kg |
| Silica | | 50 kg |
| Sodium aluminosilicate | | 130 kg |
| Synthetic fibers (FS) | | |
| Polyamide | 1.2 dtex | 45 kg |
| | length = 4 mm | |
| Polyester | 1.2 dtex | 45 kg |
| | length = 4 mm | |

The mixture of natural fibers has previously undergone a refining step according to the current paper-making method.

The following composition B is then mixed in the fibrous suspension of composition A.

Composition B

| | Dry weight in kg per |
|---|---|
| | ton of composition A |
| Cohesion agent | |
| Cationic starch | 1.5 kg |
| Moisture retention and resistance agent | |
| Cartabond ® | 27 kg |

According to the current paper-making method, the duly obtained fibrous suspension is then dripped, pressed then dried so as to obtain a sheet of 100 g/m².

Said sheet is then impregnated with the following composition C.

Composition C

| | Dry weight in kg |
|---|---|
| Additives | |
| Urea | 120 kg |
| Sodium nitrate | 60 kg |
| Binder | |
| Styrene-butadiene latex | 140 kg |
| Fillers | |
| Titanium dioxide | 60 kg |
| Water | Add to obtain a composition |
| | of 1500 L |

A fibrous layer is obtained that has a basis weight of 125 g/m².

In a variant that is not taken as an example, it would be possible to prepare a fibrous outer layer according to the invention by a method identical to that described above apart from the fact that the composition B also comprises 12 kg per ton of composition A of florescent fibers.

### Example 2

### Multilayer Card According to the Invention Having a Card Body of PVC Without RFID

The card body is made up of six layers of PVC, supplied by the company Galazzi, each having a thickness of 100 μm.

Two fibrous outer layers, each coated with an adhesive containing a polyurethane polymer on one face, are arranged on either side of the card body.

The fibrous outer layers consist of a fibrous base of composition according to the example 1, apart from the fact that, in the composition B, the polyamide synthetic fibers of 1.2 dtex and 4 mm long are replaced with polyamide synthetic fibers of 1.7 dtex and 6 mm long, the dry weight introduced remaining the same. Furthermore, a security wire that exhibits an optically variable effect has been introduced as a window in said fibrous base.

The whole of the structure is hot rolled on a plate press at 140° C. and 100 bar for 15 minutes.

The resulting card exhibits the same properties as a traditional PVC card and does not mark when it is folded.

Moreover, the card obtained has a thickness of 760 μm+/−80 μm, that is to say conforms to the standard ISO 7813.

### Example 3

### “100% Paper” Secure Multilayer Card

The card body is made up of three fibrous layers of composition according to the example 1, apart from the fact that, in the composition C, the styrene-butadiene latex is replaced by an acrylic latex, the dry weight introduced remaining the same. Each of the fibrous layers has a basis weight of 150 g/m² for a total thickness of 420 μm. Each of the layers is coated with Micryl 210 HP (pressure-sensitive adhesive) marketed by the company Planatol®, on one of its faces.

Two fibrous outer layers, each coated with 15 g/m² of the same pressure-sensitive adhesive on one face, are arranged on either side of the card body.

The fibrous outer layers of basis weight 175 g/m² consist of a fibrous base of composition according to the example 1 to which has been added agglomerates of red fluorescent particles and a mass marker (or “taggant”).

The whole is hot rolled at temperatures of around 130° C. and with a pressure of 100 N/cm² for 15 minutes.

The resulting card is a card consisting almost exclusively of paper. This card is more flexible than a traditional plastic card and does not exhibit any irreversible deformation after bending or folding tests as described previously to characterize the mechanical characteristics of the fibrous outer layer.

This card is secured, on the one hand, by the agglomerates of red fluorescent particles and can be detected using the detector specific to the taggant incorporated in the mass of the paper.

This card is delivered blank to the client who can then personalize it entirely by inkjet printing.

The card obtained has a thickness conforming to the standard ISO 7813.

### Example 4

### “100% Paper” Secure Multilayer Card with Radiofrequency Identification (“RFID”) Device

The card body is made up of a PAPERLAM® structure, that is to say a stacking of two layers of paper respectively of 220 and 155 g/m², manufactured according to the following method. Each layer is spreadcoated with a heat-reactivated adhesive, then an integrated microcircuit device is incorporated between the two layers before bonding. Said integrated microcircuit device is adapted to the contactless communication technology described in the standard ISO 14443, and is, for example, a module chip and an antenna produced by wire embedding.

Method for Manufacturing One of the Paper Layers Constituting the PAPERLAM® Structure

A fibrous support is manufactured on the paper machine so that the support comprises a fibrous base consisting of approximately 15 wt % dry, relative to the finished paper, of polyamide synthetic fibers, approximately 6 mm long, of mass per unit length approximately 1.7 dtex, and approximately 56% cellulosic fibers. The cellulosic fibers are made up of 80 wt % of long fibers and 20 wt % of short fibers.

The support also comprises approximately 13 wt %, relative to the finished paper, of at least one inorganic filler, introduced either at the refining stage, or later, in the mixing machine. The inorganic filler is, for example, kaolin.

The fibrous base, after formation as a sheet, is surfaced on the paper machine by a size press system. The size press contains 4 wt % dry relative to the bath of a binder, for example polyvinyl alcohol, 15 wt % dry relative to the bath of a softener, for example glycerin, and 4 wt % dry relative to the bath of pigments, for example kaolin, or a final dry extract of 23%.

During the impregnation in the size press, the paper is impregnated with approximately 40 g/m² of wet bath, or a dry takeup of approximately 9 g/m² dry.

The fibrous base is then coated on both its faces using an air knife coating machine, with a coating sauce comprising 30 parts of coating binder of acrylic styrene type and 100 parts of a mixture of pigments based on calcium carbonate, aluminohydrate and sodium silicate.

The coating on the support is of the order of 10 g/m² dry per face, for example.

This coated support offers a good resistance to tearing by virtue of the presence of the 6 mm synthetic fibers. It also offers a certain flexibility because of the presence of the synthetic fibers, of the fillers in the mass and on the surface, as well as the glycerin.

Finally, through the presence of the surface layer comprising at least one thermoplastic binder, it offers a good aptitude for the insertion of an ultrasound antenna and, by virtue of the presence of so-called absorbent fillers such as aluminosilicate and hydrate, an absorption capacity and a surface energy favorable to subsequent lamination.

Two fibrous outer layers, each coated with a heat-reactivated adhesive on one face, are arranged on either side of the above structure and sandwich the PAPERLAM® structure.

The fibrous outer layers consist of a fibrous base of composition according to the example 1, apart from the fact that, in the composition C, the 60 kg of titanium dioxide are replaced by 40 kg of titanium dioxide and 20 kg of kaolin. The total substance weight of the fibrous outer layers is equal to 2×175=350 g/m². Fluorescent security fibers and boards have been added to the fibrous outer layers.

The assembly is laminated on a plate press at temperatures of around 130° C., a pressure of 100 N/cm² for 15 minutes.

The resulting card is an electronic card (identity card, driving license, residence card, etc.) secured by the RFID system and identifiable by virtue of the fluorescent security fibers and the boards.

These cards are supplied pre-printed by offset printing and are personalized by inkjet printing, for example with the name of the holder of the card and/or his or her photograph.

The card obtained has a thickness conforming to the standard ISO 7813.

### Example 5

### “Mixed” Secure Multilayer Card, For Example 80% Paper and 20% PVC with Radiofrequency Identification (“RFID”) Device and Contact Module (Such a Card is Commonly Called “Dual Interface Card”)

The card body is made up of a PAPERLAM® structure with a module chip and an antenna produced by wire embedding as well as a 100 μm PVC layer on either side of the PAPERLAM® structure.

Two fibrous outer layers, each coated on one face with a heat-activated adhesive consisting of an acrylic-based polymer, are arranged on either side of the PVC layers which sandwich the PAPERLAM® structure.

The fibrous outer layers consist of a fibrous base of composition according to the example 1 onto which a holographic film has been applied.

The assembly is laminated on a plate press at temperatures of around 130° C., a pressure of 100 N/cm² for 15 minutes.

Furthermore, a contact module similar to those used in bank cards is inserted on the surface of the card by punching a fibrous outer layer and a PVC layer.

The resulting card is an electronic card (bank card, social security card, etc.) secured by the radiofrequency identification (“RFID”) system and the contact module and identifiable by virtue of the holographic film.

These cards are supplied pre-printed by offset printing and are personalized (for example with a photograph of the holder of the card) by inkjet printing.

### Example 6

### “100% Paper” Ticket with Radiofrequency Identification (“RFID”) Device

The card body consists of a PET layer with an “etched” aluminum antenna (that is to say, produced by metal ablation) and a chip deposited by a holding-placement tool (flip chip), as well as a fibrous layer of 130 g/m² according to the “Method for manufacturing one of the paper layers forming the PAPERLAM® structure”. Said fibrous layer is coated with a heat-activated adhesive to compensate the thickness of the chip. The duly obtained support has an open cavity in which the “flip chip” is housed.

Two fibrous outer layers, each coated with a heat-activated adhesive on one face, are arranged on either side of the card body.

The fibrous outer layers consist of a fibrous base of composition according to the example 1 to which fluorescent security fibers have been added.

The assembly is laminated on a roll press at a temperature of around 130° C.

The resulting structure is printed by offset printing then cut to the desired size.

The thickness of the structure is around 350 to 400 μm, this structure can, for example, be used as a loyalty card, ski pass or event ticket. In the context of an event ticket, the customization for the event will be able to be added ticket by ticket by inkjet printing.

### Examples 7

### Comparative

The following table presents different fibrous layers manufactured then evaluated by the applicant:

a cell marked with a cross (“x”) indicates that the ingredient indicated at the head of the column is present in the composition of the corresponding line,

if an ingredient is present, the quantity of this ingredient is the same as that indicated in the example 1, and

a cell marked with a minus sign (“−”) indicates that the ingredient indicated at the head of the column is present in the composition but in a quantity less than the minimum value of this ingredient in a fibrous outer layer according to the invention.

| Comparative | Cellulosic | Synthetic | Inorganic | | |
|---|---|---|---|---|---|
| example | fibers | fibers | fillers | Binder | Softener |
| C1 | x | x | | | |
| C2 | x | x | X | x | |
| C3 | x | | X | x | x |
| C4 | x | x | — | x | x |
| C5 | x | x | | x | x |

Comparative Tests: Table of Results

The following properties of the fibrous outer layers according to the example 1 and according to the comparative examples 1 to 5 are evaluated:

the Young's modulus is measured according to the standard ISO 1924 “paper and board—determination of tensile properties” (“part 2: constant rate of elongation method”),

the double-fold endurance is measured according to the standard ISO 5626 “paper-determination of folding endurance”,

the elongation at break is measured according to the standard ISO 1924 “paper and board—determination of tensile properties” (“part 2: constant rate of elongation method”), and

the printability is assessed visually according to an assessment scale described hereinbelow.

To assess the printability, two sheets of the fibrous outer layer considered are printed by means of the following printers:

5-color offset printer, and

inkjet printer (Epson Stylus D120).

An overall score is then assigned for the 2 sheets corresponding to a given fibrous outer layer:

the value 0 indicates that the fibrous outer layer is not printable; these are in particular layers which do not allow the ink to dry or on which the printing exhibits smearing,

the value 1 indicates an average printability; this is in particular a print whose resolution can be estimated at a value of between 180 and 600 dpi (dots per inch), and

the value 2 indicates a good printability; this is in particular a print whose resolution can be estimated at a value greater than 600 dpi.

| | Young's | Double-fold | | |
|---|---|---|---|---|
| | modulus | endurance | Elongation | |
| Example | (Mpa) | (number of cycles) | at break (%) | Printability |
| 1 | 1000 | 7100 | 5.3 | 2 |
| C1 | 4100 | 250 | 2.3 | 0 |
| C2 | 2200 | 550 | 2.6 | 2 |
| C3 | 3800 | 650 | 2.4 | 2 |
| C4 | 1000 | 7100 | 5.1 | 1 |
| C5 | 1000 | 7100 | 5.2 | 0 |

The results given in the table above demonstrate the advantageous effects, in terms of printability and of mechanical properties of a fibrous layer, produced by an association according to the invention of natural, and synthetic fibers, inorganic fillers, a binder and a softener.

A multilayer card according to the invention can, for example, be a bank card, a social security card, a loyalty card, a ski pass, an event ticket or an electronic card (identity card, driving license, etc.).

The expression “comprising a” should be understood to mean “comprising at least one”.

Unless stipulated otherwise, the expression “between . . . and . . . ” should be understood to include the limit values.

1-23. (canceled)

24. A multilayer card comprising a fibrous outer layer, the fibrous outer layer comprising:
relative to a total weight of the fibrous outer layer, between about 55 wt %and about 80 wt % of natural fibers,
relative to the total weight of the fibrous outer layer, between about 3 wt % and about 10 wt % of synthetic fibers,
relative to the total weight of the fibrous outer layer, between about 9 wt % and about 20 wt % of inorganic fillers,
a binder, and
a softener,
the fibrous outer layer being printed upon and/or comprising a security element.

25. The card as claimed in claim 24, wherein the inorganic fillers comprise at least silica, sodium aluminosilicate, and titanium dioxide.

26. The card as claimed in claim 25, wherein a percentage weight of silica is between about 1 wt % and about 10 wt % relative to the total weight of the fibrous outer layer, a percentage weight of sodium aluminosilicate is between about 1 wt % and about 9 wt % relative to the total weight of the fibrous outer layer, and a percentage weight of titanium dioxide is between about 2 wt % and about 9 wt % relative to the total weight of the fibrous outer layer.

27. The card as claimed in claim 24, the synthetic fibers comprise rayon fibers, fibers made of a thermoplastic material, and/or a mixture of such fibers.

28. The card as claimed in claim 24, wherein the fibrous outer layer comprises a mixture of fibers made of a polyamide and a polyester.

29. The card as claimed in claim 24, wherein at least about 50% by weight of the synthetic fibers are fibers of a polyamide.

30. The card as claimed in claim 24, wherein the synthetic fibers have an average length greater than about 4 mm.

31. The card as claimed in claim 24, wherein a ratio between a percentage weight of the binder and a percentage weight of the inorganic fillers, in the fibrous outer layer, is between about 0.25 and about 1.5.

32. The card as claimed in claim 24, wherein the fibrous outer layer has a basis weight of between about 90 and about 175 g/m².

33. The card as claimed in claim 24, wherein the fibrous outer layer contains a chip that is not exposed as an outer surface of the fibrous outer layer.

34. The card as claimed in claim 24, wherein at least a part of the security element of the fibrous outer layer is visible.

35. The card as claimed in claim 24, wherein at least a part of the printing of the fibrous outer layer is visible.

36. The card as claimed in claim 24, wherein the printing of the fibrous outer layer has a resolution greater than about 600 dpi.

37. The card as claimed in claim 24, wherein the fibrous outer layer forms part of a bank card, a social security card, a loyalty card, a ski pass, an event ticket, an identity card or a driving license.

38. The card as claimed in claim 24, wherein the binder is present in a percentage weight of between 3 wt % and 15 wt %, relative to the total weight of the fibrous outer layer.

39. The card as claimed in claim 24, wherein the softener is present in a percentage weight of between 2 wt % and 12 wt % relative to the total weight of the fibrous outer layer.

40. A method for manufacturing a card as claimed in claim 24 comprising:
positioning at least one fibrous outer layer as defined in claim 24 facing one face of a card body, and
assembling the fibrous outer layer and the card body.

41. The method as claimed in claim 40, wherein the card body comprises a layer of thermoplastic material and/or a fibrous layer.

42. A method for manufacturing a printed document in which a multilayer card is printed, said multilayer card comprising a fibrous outer layer, the fibrous outer layer comprising:
relative to a total weight of the fibrous outer layer, between about 55 wt % and about 80 wt % of natural fibers,
relative to the total weight of the fibrous outer layer, between about 3 wt % and about 10 wt % of synthetic fibers,
relative to the total weight of the fibrous outer layer, between about 9 wt % and about 20 wt % of inorganic fillers,
a binder, and
a softener.

43. An article comprising a multilayer card as claimed in claim 24, wherein at least a part of the printing and/or the security element of the fibrous outer layer is visible.

44. A multilayer card comprising a fibrous outer layer, the fibrous outer layer comprising:
relative to a total weight of the fibrous outer layer, between about 55 wt % and about 80 wt % of natural fibers,
relative to the total weight of the fibrous outer layer, between about 3 wt % and about 10 wt % of synthetic fibers,
relative to the total weight of the fibrous outer layer, between about 9 wt % and about 20 wt % of inorganic fillers,
a binder, and
a softener,
wherein the fibrous outer layer is configured to be printed upon.

45. A multilayer card comprising a fibrous outer layer, the fibrous outer layer comprising:
relative to a total weight of the fibrous outer layer, between about 55 wt % and about 80 wt % of natural fibers,
relative to the total weight of the fibrous outer layer, between about 3 wt % and about 10 wt % of synthetic fibers,
relative to the total weight of the fibrous outer layer, between about 9 wt % and about 20 wt % of inorganic fillers,
a binder, and
a softener,
wherein at least one dimension of the multilayer card conforms to the ISO 7810 standard and/or the ISO 7813 standard.

46. A multilayer card comprising a printed fibrous outer layer, the fibrous outer layer comprising:
relative to a total weight of the fibrous outer layer, between about 55 wt % and about 80 wt % of natural fibers,
relative to the total weight of the fibrous outer layer, between about 3 wt % and about 10 wt % of synthetic fibers,
relative to the total weight of the fibrous outer layer, between about 9 wt % and about 20 wt % of inorganic fillers,
a binder, and
a softener.
